(19) United States
(12) Patent Application Publication
(10) Pub. No.: US 2020/0310899 A1
(43) Pub. Date: Oct. 1, 2020

(54) METHOD FOR RETRIEVING METADATA FROM CLUSTERS OF COMPUTING NODES WITH CONTAINERS BASED ON APPLICATION DEPENDENCIES

(71) Applicant: HEWLETT PACKARD ENTERPRISE DEVELOPMENT LP, Houston, TX (US)

(72) Inventors: Koteswara Rao Kelam, Bangalore (IN); Krishna Mouli Tankala, Bangalore (IN)

(21) Appl. No.: 16/817,566

(22) Filed: Mar. 12, 2020

(30) Foreign Application Priority Data
Mar. 28, 2019 (IN) 201941012273

(51) Int. Cl. G06F 11/07

(52) U.S. Cl. CPC G06F 11/079; G06F 11/0787; G06F 11/0751

(57) ABSTRACT

The current invention discloses a method for retrieving metadata from one or more clusters of computing nodes. The method, performed by a container orchestration container, comprises detecting failure of a first application instance of a first application running on a first computing node of the one or more clusters; determining a plurality of associated application instances of one or more applications running on one or more computing nodes of the one or more clusters, wherein the associated application instances are determined based on dependencies related to the failed application instance of the first application; and retrieving metadata associated with the failed application instance and the determined plurality of associated application instances from corresponding computing nodes, for fault analysis.

### BACKGROUND

The current invention relates to software containers and retrieval of log data from clusters of containers nodes. Software container is logical block containing an application and all its dependencies and libraries, which can be executed in isolated, controlled and easy-to-deploy manner in any computing environment. Containers can be deployed on private, public or hybrid clouds, can run on a single machine and share the operating system kernel, while maintaining resource isolation.

### BRIEF DESCRIPTION OF THE DRAWINGS

The following detailed description references the drawings, wherein:

FIG. 1 is a block diagram of an example system for retrieving metadata from one or more clusters of computing nodes with containers using application dependencies;

FIG. 2 is a flowchart of an example method for retrieving metadata from one or more clusters of computing nodes with containers using application dependencies;

FIG. 3 is an example snippet of a configuration file of an application deployed as container in a computing node from the one or more clusters;

FIG. 4 is a block diagram of an example controller with machine-readable medium for retrieving metadata from one or more clusters of computing nodes with containers using application dependencies; and

FIG. 5 is flowchart of another example method for retrieving metadata from one or more clusters of computing nodes with containers using application dependencies.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

The current invention discloses a method for retrieval of metadata from clusters of computing nodes with containers based on application dependencies. Conventionally, upon the occurrence of faults in a cluster of nodes with containers, log data from entire cluster is retrieved by the cloud management platform. The log data is then analyzed to identify the cause of the fault and perform corrections in the configuration of the cluster. However, there are certain technical limitations with this approach. Firstly, since the log data (also referred to as support dump) is for the entire cluster, the log data is often substantial in size and requires considerable network bandwidth in order to be made available on the cloud management platform. Moreover, given the considerable size of the data, parsing the data requires considerable time and computation efforts. Additionally, since the containers may be deployed on any computing environment (such as private cloud, public cloud, on premise data center, etc.,), generating a consolidated support dump from nodes of different clusters may be challenging. The limitations are addressed by the current invention. The current invention discloses a method and controller for retrieving metadata from the one or more clusters, associated with a fault in a node based on application dependencies (also referred to as dependency information). This is further explained below.

In a first aspect, the current invention discloses a method for retrieving metadata from one or more clusters of computing nodes. The method comprises detecting failure of a first application instance of a first application running on a first computing node of the one or more clusters; determining a plurality of associated application instances of one or more applications running on one or more computing nodes of the one or more clusters, wherein the associated application instances are determined based on dependencies related to the failed application instance of the first application; and retrieving metadata associated with the failed application instance and the determined plurality of associated application instances from corresponding computing nodes, for fault analysis.

In an embodiment, the first node from includes application configuration of the first application indicative of dependencies between a plurality of application instances running on one or more computing nodes of the one or more clusters and the first application.

In an embodiment, the method further comprises identifying a second application instance of the first application running on at least one computing node of the one or more clusters, determining a plurality of associated application instances of one or more applications running on one or more computing nodes of the one or more clusters, wherein the associated application instances are determined based on dependencies related to the second application instance of the first application; retrieving metadata associated with the second application instance and the determined plurality of associated application instances associated with the second application instance from corresponding computing nodes; and performing fault analysis based on a comparison of metadata associated with the failed application instance of the first application and determined plurality of associated application instances associated with the first application instance, and metadata associated with the second application instance of the first application and determined plurality of associated application instances associated with the second application instance.

In an embodiment the metadata associated with the failed application instance of the first application and determined plurality of associated application instances, includes logs of the failed application instance of the first application and determined plurality of associated application instances, wherein each log includes one or more received user commands along with corresponding timestamps, and output associated with the received user commands. In another embodiment the metadata associated with the failed application instance of the first application and determined plurality of associated application instances, includes configuration associated with the failed application instance and the determined plurality of application instances.

In an embodiment a first set of one or more computing nodes from the plurality of computing nodes, are on a cloud infrastructure, and a second set of one or more computing nodes from the plurality of computing nodes, are on a dedicated on-premise infrastructure.

In a second aspect, the current invention discloses a cloud management system for managing a plurality of application instances running in a plurality of containers on a plurality of computing nodes in one or more clusters. The cloud management system comprises a controller connected to one or more computing nodes on a cloud infrastructure, and one or more computing nodes on a dedicated on-premise infrastructure. The controller is for detecting failure of a first application instance of a first application running on a first container in a computing node of the one or more clusters; determining a plurality of associated application instances of one or more applications running on a plurality of containers in the plurality of computing nodes of the one or more clusters based on dependencies related to the failed application instance of the first application using dependency information of the first application, wherein the dependency information is indicative of dependencies between a plurality of application instances running on the plurality of containers in plurality of computing nodes of the clusters and the first application; and retrieving metadata associated with the failed application instance and the determined plurality of associated application instances from corresponding computing nodes, for fault analysis.

In a third aspect, the current invention discloses a non-transitory machine-readable storage medium storing instructions that, when executed by at least one processor, cause the at least one processor to detect failure of a first application instance of a first application running on at least one computing node of one or more clusters; determine a plurality of associated application instances of one or more applications running on one or more computing nodes of the one or more clusters based dependencies related to the failed application instance of the first application using dependency information associated with the first application on the at least one computing node, wherein the dependency information is indicative of dependencies between a plurality of application instances running on one or more computing nodes of the cluster and the first application; and retrieve metadata associated with the failed application instance and the determined plurality of associated application instances from corresponding computing nodes, for fault analysis.

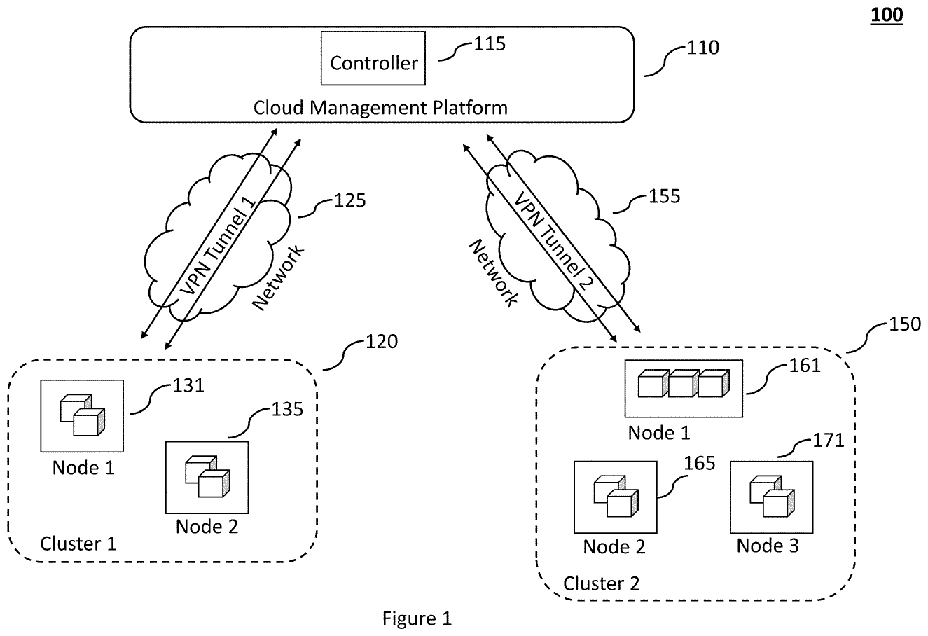

FIG. 1 is a block diagram of a system 100 for retrieving metadata from one or more clusters (120 and 150) of computing nodes (131, 135, 161, 165 and 171) with containers using application dependencies. The system 100 includes a cloud management platform 110. The cloud management platform 110 is connected to one or more clusters of computing nodes (shown in FIG. 1 as cluster 120 and cluster 150) via VPN tunnels (tunnel 125 and tunnel 155) over one or more networks. In an embodiment, the VPN tunnels 125 and 155 are over the Internet. Each cluster from the one or more clusters (120 and 150) includes a plurality of interconnected computing nodes.

As generally described herein, a node refers to a computing device on a network, either a virtual or physical machine, such as a personal computer, a cell phone, a printer, or a server, among others. Each node (131, 135, 161, 165, 171) includes a set of physical hardware that includes any number of processing resources (e.g., central processing units, graphics processing units, microcontrollers, application-specific integrated circuits, programmable gate arrays, and/or other processing resources), storage resources (e.g., random access memory, non-volatile memory, solid state drives, hard disk drives HDDs, optical storage devices, tape drives, and/or other suitable storage resources), network resources (e.g., Ethernet, IEEE 802.11 Wi-Fi, and/or other suitable wired or wireless network resources), I/O resources, and/or other suitable computing hardware. Each node may have metadata associated with it, which may be in the form of labels or annotations specifying different attributes (e.g., application configuration attributes) related to the node. Each node is connected to every other node in the cluster and is capable transferring data and applications to every other node in the cluster. A first set of one or more computing nodes from the plurality of computing nodes are deployed on a dedicated on-premise infrastructure. Similarly, a second set of one or more computing nodes from the plurality of computing nodes are deployed on a cloud infrastructure.

A plurality of containers may be deployed in each node from the clusters. For example, FIG. 1 illustrates cluster 120 having two nodes: node 131 and node 136. Node 131 and node 136 include a plurality of containers (shown in FIG. 1 as cubes) deployed on the nodes. Similarly, cluster 150 includes nodes 161, 165 and 171. Nodes 161, 165 and 171 include a plurality of containers (shown in FIG. 1 as cubes) deployed on the nodes.

Each container is logical environment containing one or more applications and all resources and libraries, which can be executed in isolated, controlled and easy-to-deploy manner in any computing environment. The container may encapsulate application resources, libraries, environmental variables, and/or other resources for use by the application. Each container may have metadata specifying different requirements and attributes associated with the container. Each container may include any suitable number of applications along with libraries, environmental settings, variables, etc., that create an independent execution environment. Thus, applications within the container have a discrete and isolated runtime environment.

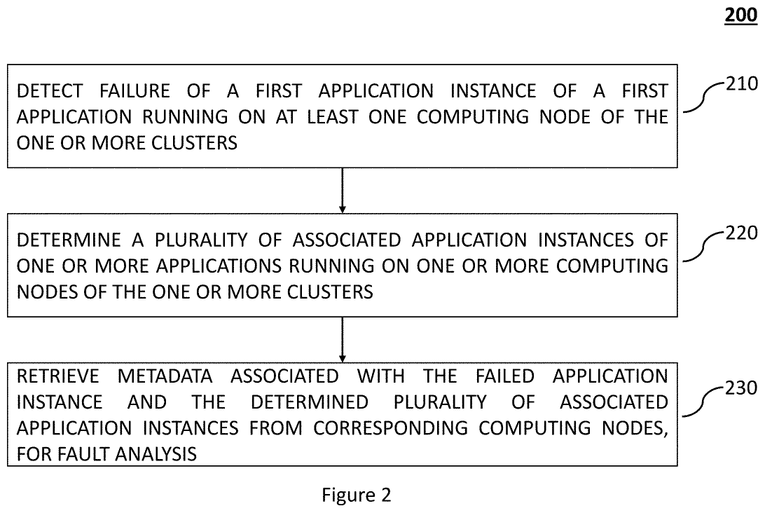

Management of the containers in the nodes can be via a container orchestration controller 115, such as, for example, Docker Swarm, Kubermetes, Amazon EC2 Container Service, Azure Container Service, or any other system for deploying to and managing containers on a node or cluster of nodes. Such container orchestration controllers (illustrated in FIG. 1 as controller 115) enable deployment, management and various other operations associated with the containers. The container orchestration controller 115 (also referred to as controller 115) is deployed on the cloud management platform 110 and connected to the plurality of computing nodes (131, 135, 161, 165 and 171). In an embodiment, at least one computing node from each cluster includes a corresponding container agent which is responsible for communicating with the controller 115 for management of the corresponding container. In an aspect related to management, the container orchestration controller 115 is responsible for detection of failure of an application instance in a container, and retrieves logs upon occurrence of the failure of an application instance to determine root cause of the fault or anomaly. The controller 115 monitors running application instances on the containers via the container agents. Upon detection of a failure of application instance, the controller 115 (and one or more container agents) determines one or more application instances which are associated with the failed application instance. Accordingly, the controller 115 (and the one or more container agents) retrieve metadata related to the failed application instance and the associated one or more application instances. In an embodiment, the retrieval of metadata is performed by the controller 115 upon receiving input from a user to initiate the retrieval. The controller 115 utilizes the metadata to determine root cause of the failed application instance. This is further explained in the description of the FIG. 2.

FIG. 2 illustrates a method 200 for retrieving metadata from one or more clusters (120 and 150) of computing nodes (131, 135, 161, 165 and 171) with containers using application dependencies. At step 210, the controller 115 detects a failure of a first application instance of a first application running on at least one computing node 131 of the one or more clusters (for example cluster 120). The controller 115 communicates with a first container agent of a first container on which the first application instance is running, for monitoring the plurality of application instances running on the first container. Accordingly the controller 115 along with the first container agent detects the failure of the first application instance using plurality of techniques known in the state of the art. For example, the controller 115 (and the first container agent) rely on heartbeat messages from first application instance to monitor the first application instance.

At step 220, the controller 115 determines a plurality of associated applications of one or more applications running on one or more computing nodes (131, 135, 161, 165 and 171), wherein the associated application instances are determined based on dependencies related to the failed application instance of the first application. In an embodiment, each application includes an application configuration (also referred to as configuration file) in the container. The configuration file includes properties of the application within the container (e.g., application role, application name, brand, version, features, build parameters, and/or other suitable properties) and is stored within the first container. Additionally, the configuration file includes references to other applications which have a dependency relationship with the first application. Based on the configuration file of the application of the failed application instance, the controller 115 (via the first container agent) determines the one or more applications which have a dependency relationship with the first application. In an embodiment, the controller 115 builds a data structure (such as a dependency tree) indicative of the dependencies upon deployment on applications on the clusters. In an embodiment, the dependency tree is built dynamically upon fault detection. Subsequent to determining the one or more applications, the controller 115 communicates with the container agents of the plurality of containers on the plurality of nodes on the cluster 120 and cluster 150 to determine application instances of the determined one or more applications. The associated application instances may run on the first container or any other container on the one or more computing nodes on the clusters. For example, an associated application instance may be on a computing node 161 of the cluster 150, while the first application instance was running on a first container on the computing node 131 of the cluster 120.

At step 230, the controller 115 (along with the container agents) retrieves metadata associated with failed application instance and the plurality of associated application instances from the corresponding containers on the corresponding computing nodes on the clusters 120 and 150, for fault analysis. Metadata retrieved by the controller 115 includes logs of the application instances including list of user commands along with corresponding time stamps and corresponding outputs of the user commands. In an example, the metadata further comprises configuration files associated with the failed application instance and the determined plurality of application instances. In an example, the controller 115 performs fault analysis by correlating failure timestamp of the first application instance, user commands temporally proximal to the failure timestamp and error and warning messages from log data of failed application instance and associated application instances.

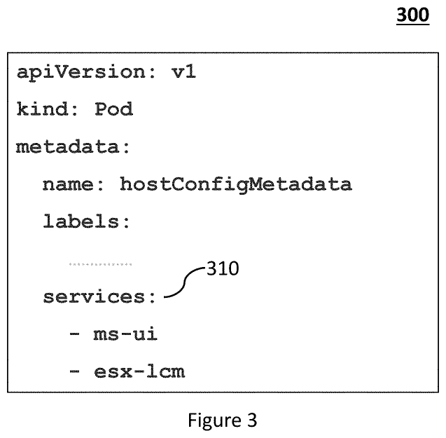

FIG. 3 illustrates an example snippet 300 of a configuration file of a first application deployed on a first container in a computing node 131 from the cluster 120. As illustrated in the figure, the configuration file includes services section 310 which includes references to the associated applications with which the current first application has a dependency relationship. Accordingly, the controller 115 and the first container agent determine the application instances which have dependencies in relation to the current first application, upon the failure of a first application instance of the current first application.

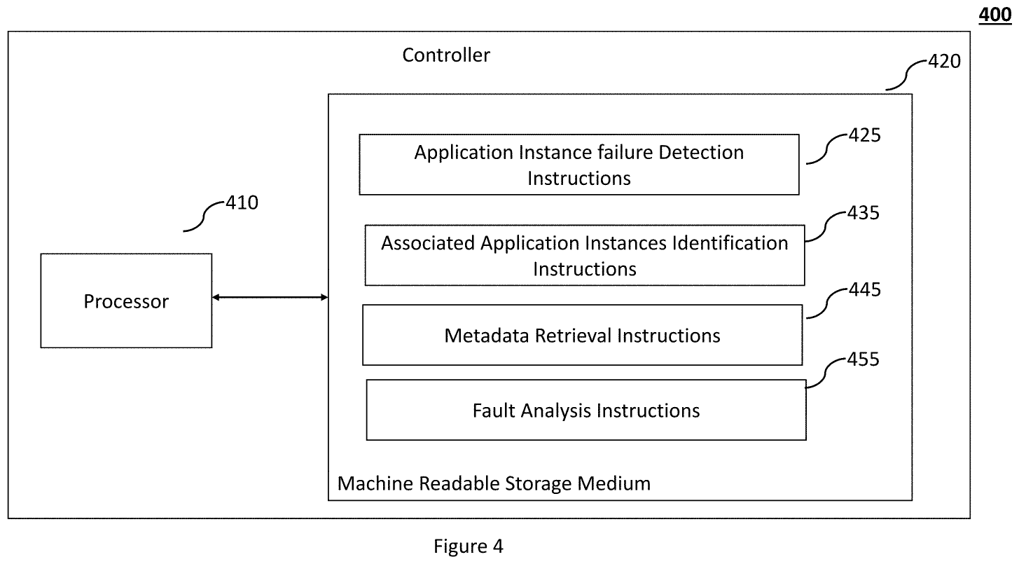

FIG. 4 is a block diagram of a controller 400 with machine-readable medium 420 for retrieving metadata from one or more clusters of computing nodes with containers using application dependencies. Machine-readable medium 420 is communicatively coupled to a processor 410. The controller 400 (machine-readable medium 420 and processor 410) may, for example, be included as part of computing system 100 illustrated in FIG. 1. Although the following descriptions refer to a single processor and a single machine-readable storage medium, the descriptions may also apply to a system with multiple processors and/or multiple machine-readable storage mediums. In such examples, the instructions may be distributed (e.g., stored) across multiple machine-readable storage mediums and the instructions may be distributed (e.g., executed by) across multiple processors.

Processor 410 may be central processing units (CPUs), microprocessors, and/or other hardware devices suitable for retrieval and execution of instructions stored in machine-readable storage medium 420. In the example shown in FIG. 4, processor 410 may fetch, decode, and execute machine-readable instructions 420 (including instructions 425-455) for retrieving metadata from one or more clusters of computing nodes with containers using application dependencies. As an alternative or in addition to retrieving and executing instructions, processor 410 may include electronic circuits comprising a number of electronic components for performing the functionality of the instructions in machine-readable storage medium 300. With respect to the executable instruction representations (e.g., boxes) described and shown herein, it should be understood that part or all of the executable instructions and/or electronic circuits included within one box may, in some examples, be included in a different box shown in the figures or in a different box not shown.

Machine-readable storage medium 420 may be any electronic, magnetic, optical, or other physical storage device that stores executable instructions. Thus, machine-readable storage medium 420 may be, for example, Random Access Memory (RAM), a nonvolatile RAM (NVRAM) (e.g., RRAM, PCRAM, MRAM, etc.), an Electrically-Erasable Programmable Read-Only Memory (EEPROM), a flash memory, a storage drive, an optical disc, and the like. Alternatively, machine-readable storage medium 420 may be a portable, external or remote storage medium, for example, that allows a computing system to download the instructions from the portable/external/remote storage medium. In this situation, the executable instructions may be part of an “installation package”. As described herein, machine-readable storage medium 420 may be encoded with executable instructions for retrieving metadata from one or more clusters of computing nodes with containers using application dependencies.

Referring to FIG. 4, application instance failure instructions 425, when executed by processor 410, may cause the processor to monitor and detect failure of an application instance in at least one container in one node from the one or more clusters. Associated application instances identification instructions 435, when executed by the processor 410, may cause the processor to determine one or more application instances with dependencies in relation to the failed application instance based on the configuration file of the application of the failed application instance. Metadata retrieval instructions 445, when executed by the one or more processors 410, may cause the processor to retrieve metadata associated with the failed application instance and associated application instances. Fault analysis instructions 455, when executed by the one or more processors 410, may cause the processors 410 to determine potential one or more root causes for the failure of the failed application instance based on the analysis of the metadata associated with the failed application instance and associated application instances.

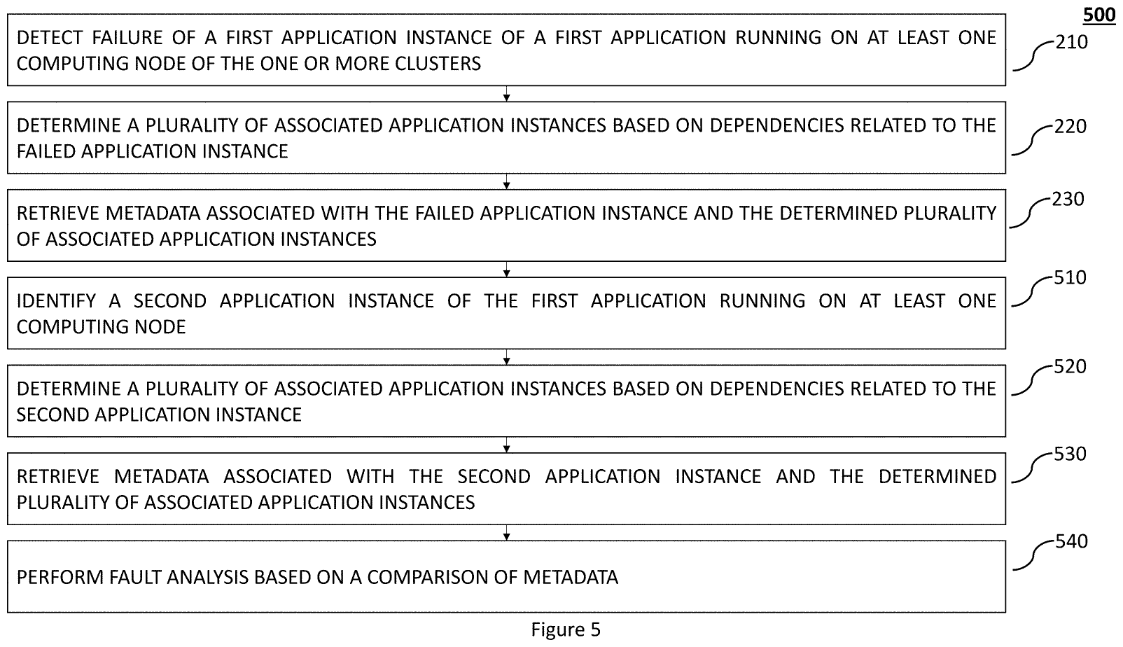

In an embodiment, the method 200 further comprises (as shown in FIG. 5) identifying 510, by the controller 115 (along with the container agents) a second application instance of the first application running on a computing node (131, 135, 161, 165, 171). In an example, the second application instance of the first application may be running the first container. In another example, the second application instance of the first application may be running on another container on a computing node from the one or more clusters. Then, the controller 115 determines (520) a plurality of associated application instances of one or more applications running on one or more computing nodes (131, 135, 161, 165, 171) of the one or more clusters (120, 150), wherein the associated application instances are determined based on dependencies related to the second application instance of the first application. The controller 115 along with the container agents determines plurality of associated application instances of one or more applications based on the application configuration of the first application. Then, at step 530, the controller 115 retrieves metadata associated with the second application instance and the determined plurality of associated application instances from corresponding computing nodes (131, 135, 161, 165, 171). At step 540, the controller 115 performs fault analysis based on a comparison of metadata associated with the failed application instance of the first application and determined plurality of associated application instances, and metadata associated with the second application instance of the first application and determined plurality of associated application instances.

The foregoing disclosure describes a number of example implementations for retrieving metadata from one or more clusters of computing nodes with containers using application dependencies. The disclosed examples may include systems, devices, computer-readable storage media, and methods for retrieving metadata from one or more clusters of computing nodes with containers using application dependencies. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Additionally, while the current invention is described in the context of containers, the current invention may utilized in other environments such as micro services, etc.

Moreover, the disclosed examples may be implemented in various environments and are not limited to the illustrated examples. Further, the sequence of operations described in connection with FIG. 2 is an example and is not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method comprising:
detecting failure of a first application instance of a first application running on a first computing node of one or more computing nodes in one or more clusters;
determining a plurality of associated application instances of one or more applications running on one or more computing nodes of the one or more clusters, wherein the plurality of associated application instances are determined based on dependencies related to the failed first application instance of the first application; and
retrieving metadata associated with the failed first application instance and the determined plurality of associated application instances from corresponding computing nodes, for fault analysis.

2. The method as claimed in claim 1, wherein a first node includes application configuration of the first application indicative of dependencies between a plurality of application instances running on the one or more computing nodes of the one or more clusters and the first application.

3. The method as claimed in claim 1, further comprising:
identifying a second application instance of the first application running on at least one computing node of the one or more clusters;
determining a second plurality of associated application instances of the one or more applications running on the one or more computing nodes of the one or more clusters, wherein the second plurality of associated application instances are determined based on dependencies related to the second application instance of the first application;
retrieving metadata associated with the second application instance and the determined second plurality of associated application instances associated with the second application instance from corresponding computing nodes; and
performing fault analysis based on a comparison of the metadata associated with the failed first application instance of the first application and the determined plurality of associated application instances associated with the first application instance, and the metadata associated with the second application instance of the first application and the determined second plurality of associated application instances associated with the second application instance.

4. The method as claimed in claim 1, wherein the metadata associated with the failed first application instance of the first application and the determined plurality of associated application instances includes logs of the failed first application instance of the first application and the determined plurality of associated application instances, and
wherein each of the logs includes one or more received user commands along with corresponding timestamps and output associated with the received user commands.

5. The method as claimed in claim 1, wherein the metadata associated with the failed first application instance of the first application and the determined plurality of associated application instances includes configuration associated with the failed first application instance and the determined plurality of application instances.

6. The method as claimed in claim 1, wherein a first set of the one or more computing nodes are on a cloud infrastructure, and a second set of the one or more computing nodes are on a dedicated on-premise infrastructure.

7. The method as claimed in claim 4, further comprising performing fault analysis by correlating failure timestamp of the first application instance with one or more user commands temporally proximal to the failure timestamp based on the logs of the failed first application instance and the determined plurality of associated application instances.

8. A cloud management system comprising:
a controller connected to one or more computing nodes, wherein a first set of the one or more computing nodes are on a cloud infrastructure a second set of the one or more computing nodes are on a dedicated on-premise infrastructure, and the one or more computing nodes are in one or more clusters, the controller to:
detect failure of a first application instance of a first application running on a first container in a computing node of the one or more clusters;
determine a plurality of associated application instances of one or more applications running on a plurality of containers in the one or more computing nodes of the one or more clusters based on dependencies related to the failed first application instance of the first application using dependency information of the first application indicative of dependencies between a plurality of application instances running on the plurality of containers in the one or more computing nodes and the first application; and
retrieve metadata associated with the failed first application instance and the determined plurality of associated application instances from corresponding computing nodes for fault analysis.

9. The cloud management platform as claimed in claim 8, wherein at least one computing node from each cluster from the one or more clusters includes a container agent connected to the controller for managing a plurality of corresponding containers on one or more computing nodes of a corresponding cluster.

10. The cloud management platform as claimed in claim 8, wherein the controller is to:
identify a second application instance of the first application running on a container on the one or more computing nodes of the one or more clusters;
determine a second plurality of associated application instances of one or more applications running on the one or more computing nodes of the one or more clusters, wherein the second plurality of associated application instances are determined based on dependencies related to the second application instance of the first application;
retrieve metadata associated with the second application instance and the determined second plurality of associated application instances associated with the second application instance from corresponding computing nodes; and
perform fault analysis based on a comparison of the metadata associated with the failed first application instance of the first application and the determined plurality of associated application instances associated with the first application instance, and the metadata associated with the second application instance of the first application and the determined second plurality of associated application instances associated with the second application instance.

11. The cloud management platform as claimed in claim 8, wherein the metadata associated with the failed first application instance of the first application and the determined plurality of associated application instances includes logs of the failed first application instance of the first application and the determined plurality of associated application instances, and
wherein each tog of the logs includes one or more received user commands along with corresponding timestamps and output associated with the received user commands.

12. The cloud management platform as claimed in claim 8, wherein the metadata associated with the failed first application instance of the first application and the determined plurality of associated application instances includes configuration associated with the failed first application instance and the determined plurality of application instances.

13. The cloud management platform as claimed in claim 11, wherein the controller is further to perform fault analysis by correlating failure timestamp of the first application instance with one or more user commands temporally proximal to the failure timestamp based on the logs of the failed first application instance and the determined plurality of associated application instances.

14. A non-transitory machine-readable storage medium storing instructions that, when executed by a processor, cause the processor to:
detect failure of a first application instance of a first application running on at least one computing node of one or more clusters;
determine a plurality of associated application instances of one or more applications running on one or more computing nodes of the one or more clusters based on dependencies related to the failed first application instance of the first application using dependency information associated with the first application indicative of dependencies between the first application and a plurality of application instances running on the one or more computing nodes; and
retrieve metadata associated with the failed first application instance and the determined plurality of associated application instances from corresponding computing nodes for fault analysis.

15. The non-transitory machine-readable storage medium as claimed in claim 14 further comprising instructions that, when executed by the processor, cause the processor to:
identify a second application instance of the first application running on at least one computing node of the one or more clusters;
determine a second plurality of associated application instances of one or more applications running on the one or more computing nodes of the one or more clusters, wherein the second plurality of associated application instances are determined based on dependencies related to the second application instance of the first application;
retrieve metadata associated with the second application instance and the determined second plurality of associated application instances associated with the second application instance from corresponding computing nodes; and
perform fault analysis based on a comparison of the metadata associated with the failed first application instance of the first application and the determined plurality of associated application instances associated with the first application instance, and the metadata associated with the second application instance of the first application and determined second plurality of associated application instances associated with the second application instance.

16. The non-transitory machine-readable storage medium as claimed in claim 14, wherein the metadata associated with the failed first application instance of the first application and the determined plurality of associated application instances includes logs of the failed first application instance of the first application and the determined plurality of associated application instances and wherein each tog of the logs includes one or more received user commands along with corresponding timestamps and output associated with the received user commands.

17. The non-transitory machine-readable storage medium as claimed in claim 14, wherein the metadata associated with the failed first application instance of the first application and the determined plurality of associated application instances includes configuration associated with the failed first application instance and the determined plurality of application instances.

18. The non-transitory machine-readable storage medium as claimed in claim 14, wherein a first set of the one or more computing nodes from the plurality of computing nodes are on a cloud infrastructure, and a second set of the one or more computing nodes from the plurality of computing nodes are on a dedicated on-premise infrastructure.

19. The non-transitory machine-readable storage medium as claimed in claim 16 further comprising instructions that, when executed by the processor, cause the processor to perform fault analysis by correlating failure timestamp of the first application instance with one or more user commands temporally proximal to the failure timestamp based on the logs of the of failed first application instance and the determined plurality of associated application instances.

20. The non-transitory machine-readable storage medium as claimed in claim 14, wherein at least one computing node from each cluster from the one or more clusters includes a container agent connected to the controller, for managing a plurality of corresponding containers on one or more computing nodes of a corresponding cluster.
